(19) United States
(12) Patent Application Publication
(10) Pub. No.: US 2011/0083482 A1
(43) Pub. Date: Apr. 14, 2011

(54) CAM LOCK

(75) Inventor: Ilan Goldman, Herzliya (IL)

(73) Assignee: KNOCK N'LOCK LTD., Yokneam (IL)

(21) Appl. No.: 12/920,962

(22) PCT Filed: Mar. 4, 2009
(86) PCT No.: PCT/IL09/00246

§ 371 Date: Dec. 21, 2010

Related U.S. Application Data
(60) Provisional application No. 61/034,018, filed on Mar. 5, 2008.

(51) Int. Cl. E05B 47/06

(52) U.S. Cl. 70/280

(57) ABSTRACT

Disclosed is a cam lock assembly that includes a lock unit, a locking mechanism and a cam, the locking mechanism operating for rotating the cam between open and closed positions thereof; and a separate electrically-driven lock control module connectable to the lock unit and cooperating therewith for selectively switching the lock unit between a locked state in which the cam is in the closed position and an unlocked state in which the cam can be rotated to the open position.

### FIELD OF THE INVENTION

This invention relates to a cam lock controllable by an electric module.

### SUMMARY OF THE INVENTION

The present invention concerns a cam lock for use in cabinets, doors, etc. that is provided with an electric/electronic access control module which is attached to the lock and switches the lock between a locked state, in which the lock cannot be opened, and an unlocked state in which an external grip of the lock can be rotated to open the lock.

The present invention discloses a cam lock assembly, comprising a lock unit and a separate electrically-driven lock control module connectable thereto. The lock unit includes a lock housing that defines an exterior-interior oriented lock axis and houses a locking mechanism and includes a cam. The locking mechanism operates to rotate the cam between open and closed positions thereof. The control module is connectable to the lock unit and cooperates therewith for selectively switching the lock unit between a locked state in which the cam is in the closed position and an unlocked state in which the cam can be rotated to the open position.

The present invention discloses, by an embodiment thereof, a cam lock assembly that comprises a lock housing, first and second rotating members with the first rotating member being respective more exterior than the second, the first member having an exterior rotation grip and the second member having an interior cam. The two members rotate about the lock axis and their rotation is coupled such that rotation of said grip causes rotation of the cam between locked and open positions thereof. The first rotating member is axially displaceable between a retracted state and an extended state and biased by an urging member for displacement into the extended state, the grip being accessible for rotation in the extended state and not accessible for rotation in the retraced state. The assembly also comprises an electrically-driven lock control module connectable to the lock house and having a pin electrically switchable by radial reciprocation, respective to said axis, between a projected state and a retracted state. In its retracted state the pin head can engage a pin head receptacle in the first rotating member and upon engagement maintains the first rotating member in the retracted position.

According to one embodiment, the rotational coupling of the first and second members to one another is through a multi-facet (for example prismatic, prismatic-like with rounded edges, etc) shaft in one of the two members which is slidably received within a corresponding multi-facet lumen formed in the other rotating member.

The pin head receptacle is typically a groove formed on the surface of the first rotating member. As can be appreciated, the groove is made in a portion of the first member that is disposed within the housing. The latter has an opening at a portion overlaying the groove to provide a passage of the pin to the groove.

According to an embodiment of the invention, the groove is substantially L-shaped with a first, substantially tangentially oriented segment and a second, substantially axially oriented segment and extending from the first segment towards the exterior. A notch projects internally from the housing into the groove, engaging the groove and thus guiding and limiting the axial displacement and rotation of the first rotating member.

Also disclosed by the invention is an electrically driven lock control module for use in a cam lock assembly of the kind described and defined above.

An electrically-driven lock control module for use in a cam lock assembly for switching the lock between locked and unlocked states thereof, according to an embodiment of the invention, comprise a housing that houses the module components. The module components may comprise: a bi-stable solenoid; a solenoid slider; a rotating cam; a locking slider; and a counter-weight slider that is associated with an urging member that impart a forward bias on the counter-weight slider. The bi-stable solenoid has a spring-biased plunger that reciprocates in a forward-rearward direction to assume, respective, extended and retracted positions. Actuation of the solenoid switches the plunger between the two positions. The solenoid slider has a rear portion that abuts a front face of the plunger to thereby slide forward upon forward displacement of the plunger. The solenoid and the locking sliders are coupled through a rotating cam disposed between them, whereby forward movement of the solenoid slider causes a rearward movement of the locking slider. A a rear portion of the locking slider abuts a front portion of the counter-weight slider, whereby rearward movement of the locking slider causes a rearward movement of the counter-weight slider and a forward movement of the counter-weight slider causes a forward movement of the locking slider. The locking slider has a forward projecting lock-engaging portion that is adapted to engage with a cooperating portion in the lock for maintaining the lock in a locked state, retraction of the said portion switches the lock from the locked to an unlocked state.

Actuation of the solenoid to displace the plunger into the extended position causes a forward movement of the solenoid slider and rearward, disengaging movement of the locking slider with the lock-engaging portion and a rearward movement of the counter-weight slider against the urging force of the associated urging member. Actuation of the solenoid to move the plunger into the retracted state permits then a forward displacement of the counter-weight slider through the urging force of said urging member, yielding forward movement of locking slider and reward movement of solenoid slider.

According to one embodiment, the combined mass of the plunger and the plunger slider, on the one hand and that of the locking slider and the counter-weight slider on the other hand, are substantially the same. Typically, the mass of the solenoid slider and that of the locking slider is substantially the same. This arrangement ensure that shaking or other lock tampering attempts will not cause a net inertia that will cause a rearward, lock-disengaging movement of the locking slider. As the inertia in each side of the cam is substantially the same, there will be no uncontrolled displacement of the locking slider.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1A is a perspective view of a cam lock assembly according to an embodiment of the invention;

FIG. 1B is an exploded perspective illustration of the main part of the cam lock assembly of FIG. 1A;

FIG. 2 shows the cam lock if FIG. 1 with the housing of the lock controlled module being removed to permit viewing of internal components;

FIGS. 3 and 4 show the two rotating members of the cam lock of FIG. 1 in respective assembled and exploded views; and

FIGS. 5-10 show the cam lock assembly in six successive operative states, wherein FIGS. 5A, 6A, etc. are planar sections through the lock assembly, while FIGS. 5B, 6B, etc,. are sections through a broken plane V-V illustrated in FIG. 5A.

### DETAILED DESCRIPTION OF EMBODIMENTS

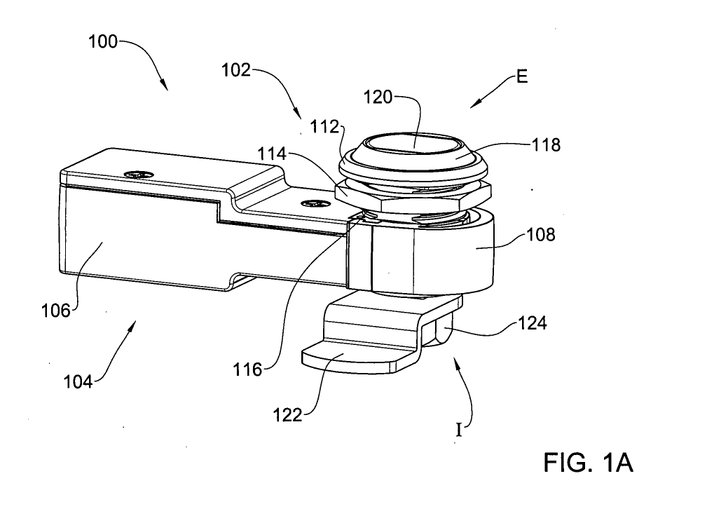

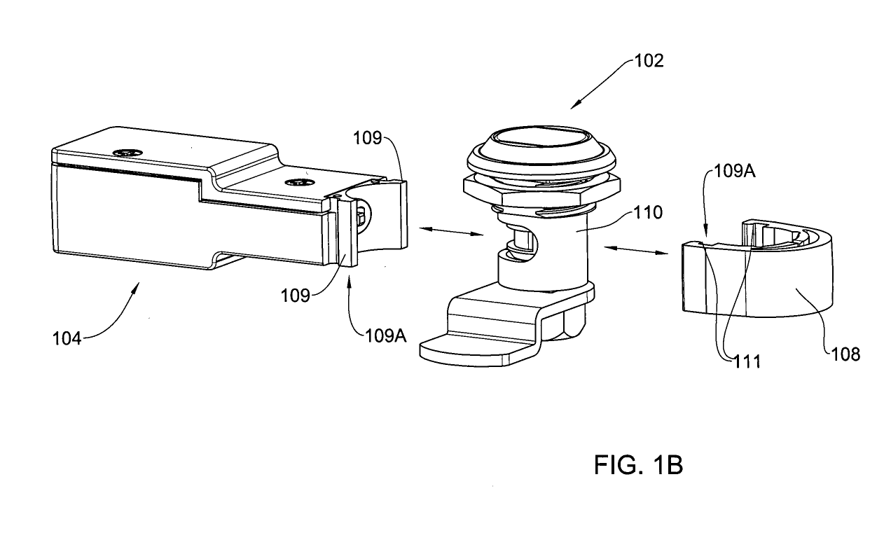

Reference is first being made to FIG. 1A and FIG. 1B illustrating an example of a lock cam assembly, generally designated 100 including a cam lock unit 102 and an electrically-driven lock control module 104 with a housing 106 fixed to the cam lock unit 102 through a holder member 108. The cam lock unit 102 has a lock housing 110 that houses a locking mechanism and defines a lock axis extending between an exterior E and an interior I. A cam 122 is fitted at the interior end I of the lock unit. As will be described below, the locking mechanism includes rotating members and operates for rotating the cam between open and closed positions thereof. The electrically-driven lock control module 104 is a separate unit connectable to the lock unit 102 and cooperating therewith for selectively switching the lock unit between a locked state in which the cam 122 is in the closed position and an unlocked state in which the cam can be rotated to the open position.

The manner of the engagement between the lock unit 102 (its housing 110) and the control module 104 is shown in FIG. 1B, in a generally self-explanatory manner. The engagement is fixed by the holder member 108 by the fitting of the pair of wing projections 109 of control module 104 and corresponding slots 111 of holder 108. The fitting is achieved through sliding movement of the holder 108 with respect to module 104 as represented by respective arrows 111A and 109A.

The lock unit 102 includes an external adapter ring 112 and fastening nut 114 threaded onto external threading 116 of housing 106. The adapter ring 112 and nut 114 are fitted on the exterior and interior faces of an external panel of a drawer, cabinet door, etc. (not shown). The locking mechanism comprises a knob-guarding ring 118 included at the exterior E is. The knob-guarding ring 118 in the locked state of the cam lock shown in FIG. 1 accommodates grip/knob 120 such that its upper face is flush with the upper rim of ring 118 whereby it cannot be gripped by a user. Grip/knob 120 forms an exterior part of the first rotating member (to be described below). Shown is also a cam 122 fitted at an interior part of a second rotating member (to be described below), fastened by a nut 124.

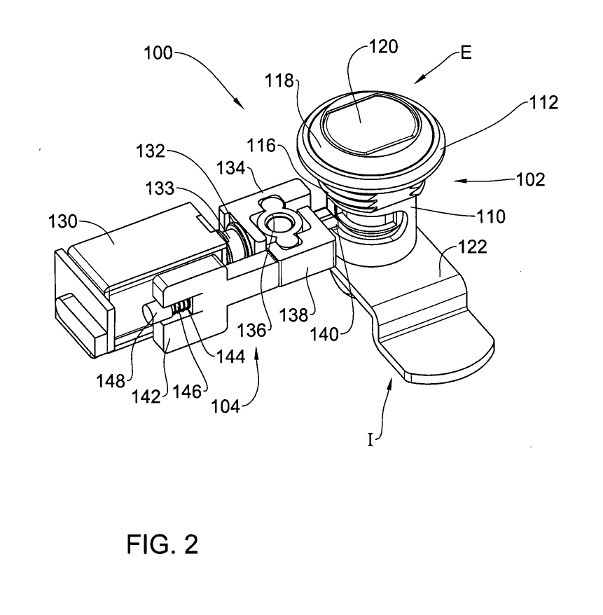

The internal components of control module 104 are seen in FIG. 2. They include a bi-stable solenoid 130 with a plunger 132 that is forward biased by an associated spring 133 (only its very end portion is seen in FIG. 2). The plunger 132 abuts slider 134 which is in turn coupled through a rotating cam 136 to a locking slider 138. Slider 138 has a forward engaging-pin 140, projecting in the radial direction in respect of the lock axis. The slider 138 abuts a counter-weight slider 142 which is biased in the forwarded direction by an urging spring 144 fitted on a shaft 146 of a body 148. Through the balancing action of plunger 132 and slider 134 on the one side, and locking slider 138 and counter-weight slider 142 on the other side, the uncontrolled back and forward movement of the locking slider 138 is prevented; and hence disengagement from a locked to a unlocked state as will be described below.

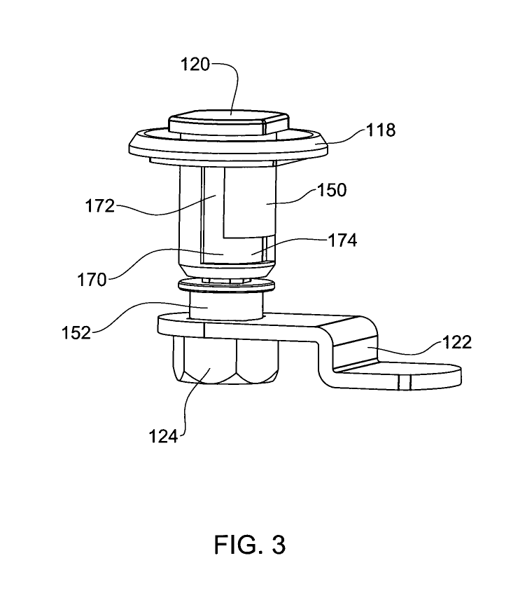

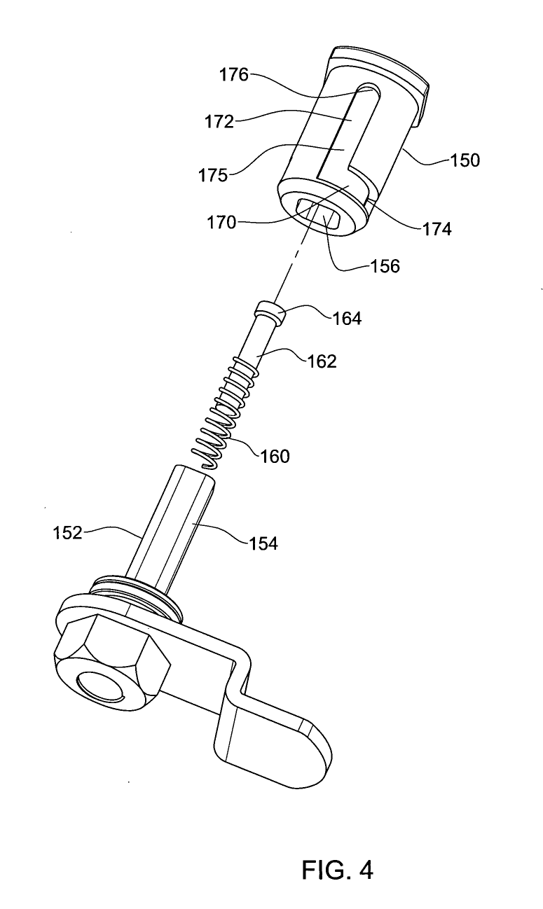

Reference is now being made to FIG. 3 and FIG. 4 showing configuration of the first rotating member 150 and the second rotating member 152 of the locking mechanism. The second rotating member 152 has a projection with a multi-facet circumference which fits in a corresponding multi-facet lumen 156 of the first member 150. Through this engagement, the two members are rotationally coupled for rotation about the lock axis. Projection 154 is slidably received within lumen 156, whereby the first rotating member 150 can axially be displaced with respect to the second member 152.

Projection 154 has a lumen which accommodates a helical spring 160 which is wound around a shaft of a pin 162. Pin 162 has a head portion 164 which, once members 150 and 152 are coupled, presses on the upper wall (not shown in this figure) of lumen 156. Through the urging force of spring 160, first member 150 is biased towards axial displacement away from second member 152.

Formed on the external surface of first member 150 is an L-shaped groove 170 with an intersecting axial and tangential sections 172 and 174, respectively, the intersection being at 175. In a manner that will become clear from the description below, groove 170 receives an end portion of a notch (not shown in this figure) that projects internally from the housing into the groove. Through this engagement the axial displacement and rotation of the first rotating member 150 is guided and limited. As may be further from the description below, at a locked state of the cam-lock, in which the first rotating member is in an axially retraced state (which is the state illustrated in FIG. 1 and FIG. 2) the notch is received at an upper end 176 of the axial segment 172. As will also be further understood from the description below, the axial displacement of member 150 is guided by the engagement of the notch end portion within the axial segment 172 of groove 170; the axial displacement is also limited through this engagement and is stopped when the axial displacement reaches a point where the notch end portion is at 175. At such stage a clockwise rotation of first rotating member is enabled which is guided and limited by tangential segment 174 of groove 170 in a manner analogous to that of the axial displacement.

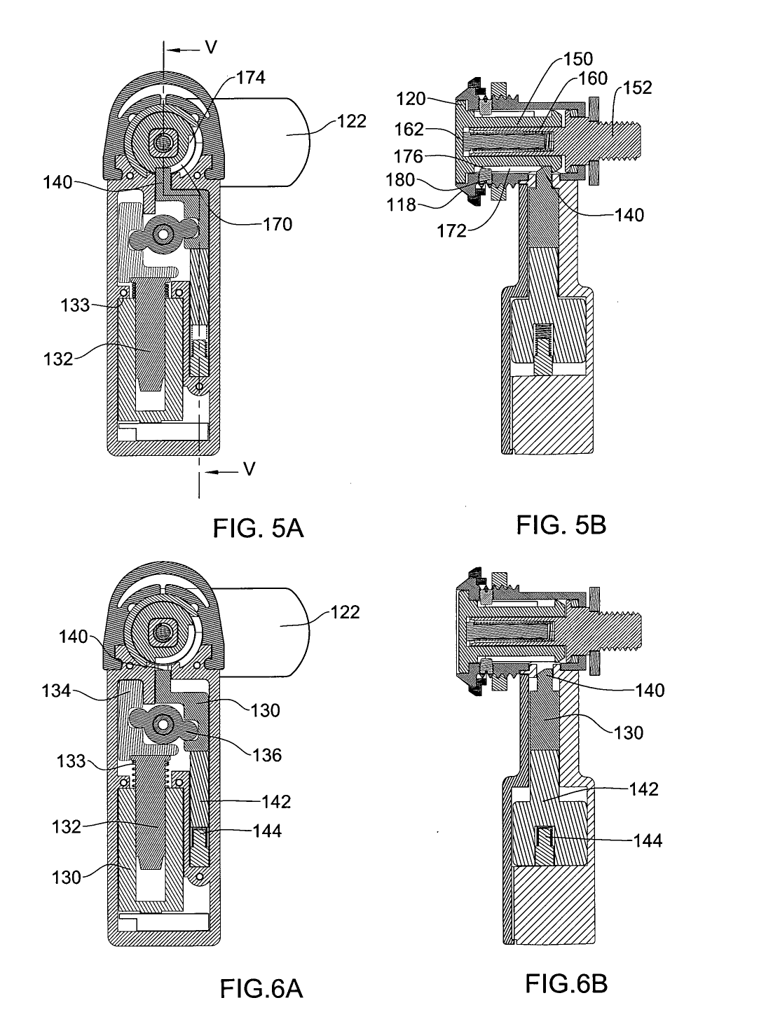

Reference is now being made to FIGS. 5A-B to FIGS. 10A-B showing cross-sectional views of the cam lock assembly in successive operative states. In the state shown in FIG. 5A and FIG. 5B, the forward engaging-pin 140 engages the L-shaped groove 170 at 175 (see FIG. 3). In this state, grip 120 is accommodated within the knob-guarding ring 118 and can thus not be accessed by a user for actuating the lock. This state is a locked state of the cam lock in which the cam 122 is in its locked position.

Internally projecting from the housing is a notch 180 that engages groove 170 at end 176 of segment 172. Also seen in FIG. 5B, is pin 162 with associates spring 160 that is compressed and thereby biases the first rotating member 150 for axial displacement away from the second rotating member 152. Also seen in FIG. 5 is the spring 133 that is associated with plunger 132 and induces a forward biasing force towards the extended position of the plunger.

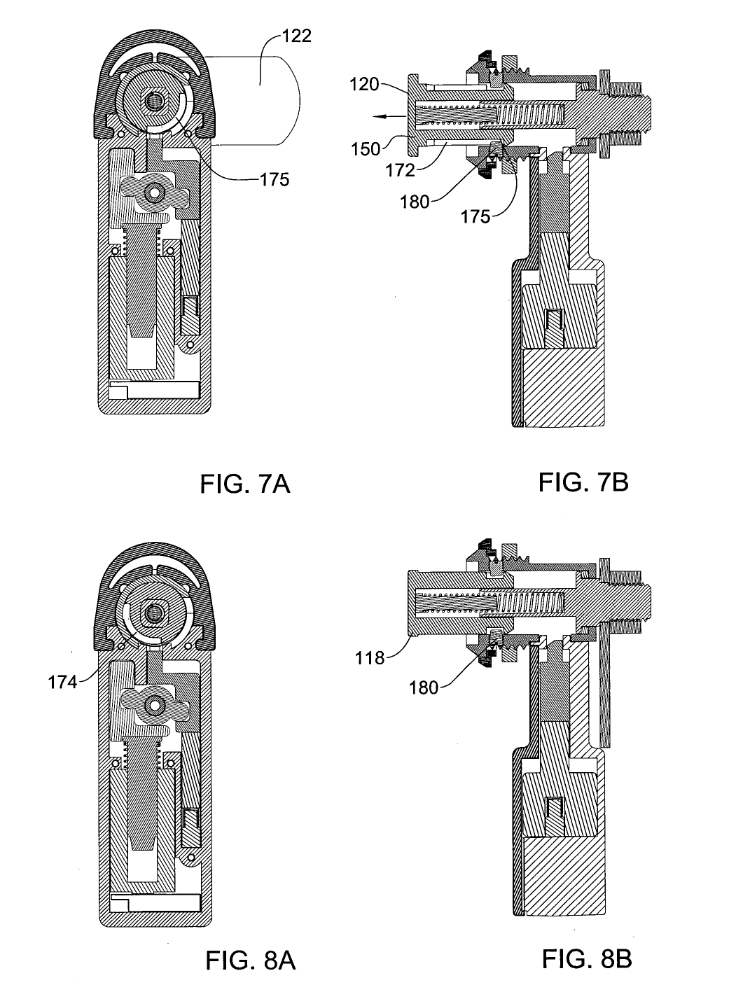

Referring to FIGS. 6A and 6B, following an electric command from a control module (not shown) solenoid 130 is actuated to forwardly displace plunger 132 which causes forward movement of slider 134. Through rotational coupling via cam 136, slider 134 causes backward sliding of locking slider 138 with its pin 140 and of counter-weight 142 against the urging force of spring 144. This permits, as shown in FIGS. 7A and 7B, the axial displacement of first rotating member 150. Notch 180 guides this axial displacement and limits it to a point in which it rest at 175 of the L-shaped groove 170. At this state, the clockwise axial rotation of grip 120 is permitted. This rotation is guided and limited by engagement of notch 180 with tangential segment 174 of the L-shaped groove 170. Through the rotational coupling, rotation of the grip 120 of first rotating member 150 causes rotation of the second rotating member 152 and hence of the cam 122 to the unlocked position thereof, as seen in FIGS. 8A and 8B (the cam is not seen in this Fig. as is below the control module 104.

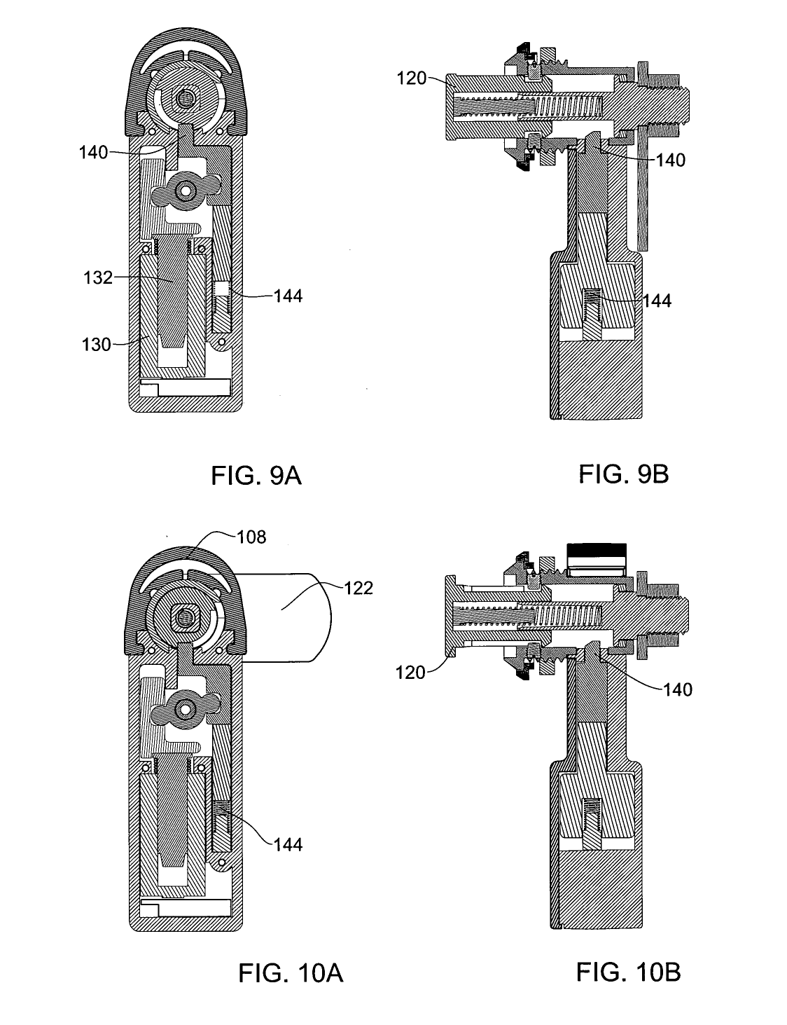

For example, through a time control mechanism, after a defined period of time, a control command actuates solenoid 130 to retract plunger 132, whereby, through the urging force of spring 144, in a reverse sequence to that described with reference to FIGS. 6A and 6B, pin 140 is pushed forward to its original position of FIG. 5A. This is illustrated in FIGS. 9A and 9B.

As can be seen in FIGS. 10A and 10B, through counter-clockwise rotation of grip 120, the cam 122 is rotated back to its locked position. Pin 140 has a slanted surface facing the first rotating member 150, whereby when the member 150 is axially pressed towards the second member the pin 140 is momentarily retracted against the urging force of spring 144 and once positioned in alignment with 175 of groove 170 it moves back into its position shown in FIGS. 5A and 5B which is the locked state of the cam lock.

Those skilled in the art to which this invention pertains will readily appreciate that numerous changes, variations, and modifications can be made without departing from the scope of the invention, mutatis mutandis.

1. A cam lock assembly, comprising:
a lock unit with a lock housing defining an exterior-interior oriented lock axis, a locking mechanism within the housing and a cam, the locking mechanism operating for rotating the cam between open and closed positions thereof; and
a separate electrically-driven lock control module connectable to the lock unit and cooperating therewith for selectively switching the lock unit between a locked state in which the cam is in the closed position and an unlocked state in which the cam can be rotated to the open position.

2. A cam lock assembly comprising:
a lock housing defining an exterior-interior oriented lock axis;
a first rotating and second rotating members with portions disposed within the housing, the first rotating member having an exterior actuation grip and the second rotating member being fitted with an interior cam, the two members rotating about the lock axis and their rotation being coupled such that rotation of the grip causes rotation of the cam between locked and open positions thereof; the first rotating member being axially displaceable between a retracted state and an extended state and biased by an urging member for displacement into the extended state, the grip being accessible for rotation in the extended state and not accessible for rotation in the retraced state; and
an electrically-driven lock control module connectable to the lock house and having a pin electrically switchable by radial reciprocation, respective to the axis, between a projected state and a retracted state; in its retracted state the pin head can engage a pin head receptacle in the first rotating member and upon engagement maintains the first rotating member in the retracted position.

3. The cam lock assembly according to claim 2, wherein one of the rotating members has a multi-facet shaft slidably received within a corresponding multi-facet lumen formed in the other rotating member.

4. The cam lock assembly according to claim 2, wherein the pin head receptacle is a groove formed on the surface of the first rotating member.

5. The cam lock assembly according to claim 4, wherein the groove is substantially L-shaped with a first, substantially tangentially oriented segment and a second, substantially axially oriented segment and extending from the first segment towards the exterior; projecting internally from the housing into the groove, is a notch that engages the grove so as to guide and limit the axial displacement and rotation of the first rotating member.

6. An electrically driven lock control module for use in the cam lock assembly claim 2.

7. An electrically-driven lock control module for use in a cam lock assembly for switching the lock between locked and unlocked states thereof, the module comprising:
a housing that houses the module components that comprise: a bi-stable solenoid; a solenoid slider; a rotating cam; a locking slider; and a counter-weight slider that is associated with an urging member that impart a forward bias on the counter-weight slider;
the bi-stable solenoid having a spring-biased plunger reciprocating in a forward-rearward direction to assume, respective, extended and retracted positions, actuation of the solenoid switching the plunger between the two positions;
the solenoid slider has a rear portion abutting a front face of the plunger to thereby slide forward upon forward displacement of the plunger; the solenoid and the locking sliders being coupled through a rotating cam disposed between them, whereby forward movement of the solenoid slider causes a rearward movement of the locking slider;
a rear portion of the locking slider abutting a front portion of the counter-weight slider, whereby rearward movement of the locking slider causes a rearward movement of the counter-weight slider and a forward movement of the counter-weight slider causes a forward movement of the locking slider;
the locking slider having a forward projecting lock-engaging portion that is configured to engage with a cooperating portion in the lock for maintaining the lock in a locked state, retraction of the portion switches the lock from the locked to an unlocked state.

8. The lock control module according to claim 7, wherein the combined mass of the plunger and the plunger slider, on the one hand and that of the locking slider and the counter-weight slider on the other hand, are substantially the same.

9. The lock control module according to claim 7, wherein the mass of the solenoid slider and that of the locking slider is substantially the same.
